(19) United States
(12) Patent Application Publication
(10) Pub. No.: US 2026/0238337 A1
(43) Pub. Date: Aug. 13, 2026

(54) SYSTEMS, METHODS, AND DEVICES FOR SSB OFFSET TRANSITION OF SATELLITE SWITCHING

(71) Applicant: Apple Inc., Cupertino, CA (US)

(72) Inventors: Jie CUI, San Jose, CA (US); Yang TANG, San Jose, CA (US); Yuqin CHEN, Beijing (CN); Qiming LI, Beijing (CN); Fangli XU, Beijing (CN); Chunxuan YE, San Diego, CA (US); Haitong SUN, Saratoga, CA (US); Dawei ZHANG, Saratoga, CA (US)

(21) Appl. No.: 19/533,084

(22) Filed: Feb. 6, 2026

Related U.S. Application Data
(60) Provisional application No. 63/755,773, filed on Feb. 7, 2025.

(51) Int. Cl. H04B 7/185; H04W 56/00

(52) U.S. Cl. CPC H04B 7/18541; H04W 56/0045

(57) ABSTRACT

The techniques described herein can include solutions for user equipment (UE) behavior) for synchronization signal block (SSB) offset transition of satellite switching. In some examples, during satellite switching, SSBs from the source satellite and target satellite can have the same periodicity while being transmitted at the same time according to a tie offset during a coverage overlap. Satellite switching can include cell searching and fine time tracking. The UE may complete cell searching, fine time tracking, or both, prior to expiration of the coverage overlap by beginning cell searching and fine time tracking earlier. After satellite switching, the time offset can be adjusted to re-synchronize the SSBs of the target satellite. In some examples, the UE may not complete cell searching, fine time tracking, or both, prior to expiration of the coverage overlap. The UE can determine the location of the target satellite based on redefined synchronization parameters.

### CROSS-REFERENCE TO RELATED APPLICATIONS

This application claims the benefit of U.S. Provisional Application No. 63/755,773, filed Feb. 7, 2025, the content of which is herein incorporated by reference in its entirety for all purposes.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for satellite communications.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example transmission timeline for synchronization signal block (SSB) offset transition of satellite switching according to one or more implementations described herein.

FIG. 4 is a diagram of an example transmission timeline for SSB offset transition of satellite switching according to one or more implementations described herein.

FIG. 5 is a diagram of an example process for SSB offset transition of satellite switching according to one or more implementations described herein.

FIG. 6 is a diagram of an example of components of a device according to one or more implementations described herein.

FIG. 7 is a diagram of example interfaces of baseband circuitry according to one or more implementations described herein.

FIG. 8 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 9 is a diagram of an example process for SSB offset transition of satellite switching according to one or more implementations described herein.

FIG. 10 is a diagram of an example process for SSB offset transition of satellite switching according to one or more implementations described herein.

### DETAILED DESCRIPTION

The following detailed description refers to the accompanying drawings. Like reference numbers in different drawings can identify the same or similar features, elements, operations, etc.

Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs and base stations can implement various techniques and communications standards for enabling UEs and base stations to discover one another, establish and maintain connectivity, and exchange information in an ongoing manner. Objectives of such techniques can include identifying UE behavior for different scenarios of soft satellite switching.

A UE can be in communication with a satellite, such as a source satellite. The UE can receive synchronization signal blocks (SSBs) and other synchronization information from the source satellite. It can be advantageous for the UE to change satellites, such as if the UE or the satellite have moved or coverage has otherwise changed. The UE can switch satellites by performing satellite switching, where the UE transitions communications from the source satellite to another satellite, such as a target satellite. In some examples, during satellite switching, a source satellite coverage and a target satellite coverage overlap while the UE transfers communications. For example, the UE continues to receive SSBs from a source satellite while searching for SSBs from a target satellite. After satellite switching, the UE can receive SSBs from the target satellite, which is the new serving satellite, and may no longer receive SSBs from the source satellite.

In some examples, the source satellite and the target satellite can have similarities. For example, SSBs from the source satellite and SSBs from the target satellite can have the same periodicity. Additionally, the target satellite and the source satellite can be a part of the same cell and have the same physical cell identifier (PCI). To avoid collision, SSBs of the target satellite can be offset from SSBs of the source satellite according to a time offset during the overlap in coverage.

To perform satellite switching, the UE can perform cell searching and fine time tracking. Cell searching can include searching for a satellite, such as the target satellite, and receiving information for synchronization, such as SSBs. Fine time tracking can include determining the location of the target satellite. The UE can initiate satellite switching during the overlapping coverage, before the source satellite stops serving the area and after the target satellite starts serving the same area. In some examples, the UE may or may not complete cell searching, fine time tracking, or both, prior to the expiration of the overlap period. Further, once the UE switches satellites, or the overlap period expires, prior synchronization information may or may not be relevant. In examples where satellite switching is partially completed prior to the expiration of the overlap period, UE behavior can be especially underdefined.

One or more of the techniques described herein address the foregoing deficiencies by providing solutions for UE behavior for SSB offset transition of satellite switching with PCI change. In some examples, the UE performs cell searching, fine time tracking, or both, prior to the expiration of the overlap in coverage. The expiration of the coverage overlap can be defined by a service time. The UE can begin cell searching and fine time tracking earlier to obtain the necessary samples of SSBs from the target satellite prior to the service time. After the service time, the time offset can be adjusted to re-synchronize the SSBs of the target satellite.

In some examples, the UE may not complete cell searching, fine time tracking, or both, prior to the service time. In such examples, synchronization information, such time offset and search time, can be adjusted. Further, parameters for UE determination of the location of the satellite can be defined. The UE can determine the location of the target satellite based on the location of the SSB of the source satellite, timing of the received SSBs (e.g., prior to the service time or after the service time), the time offset, adjusted time offset, different in propagation delay, and SSB arrival times. Additional examples described herein provide for UE behavior for measurements performed before and after the service time, additional methods of determining a target satellite location, among other examples.

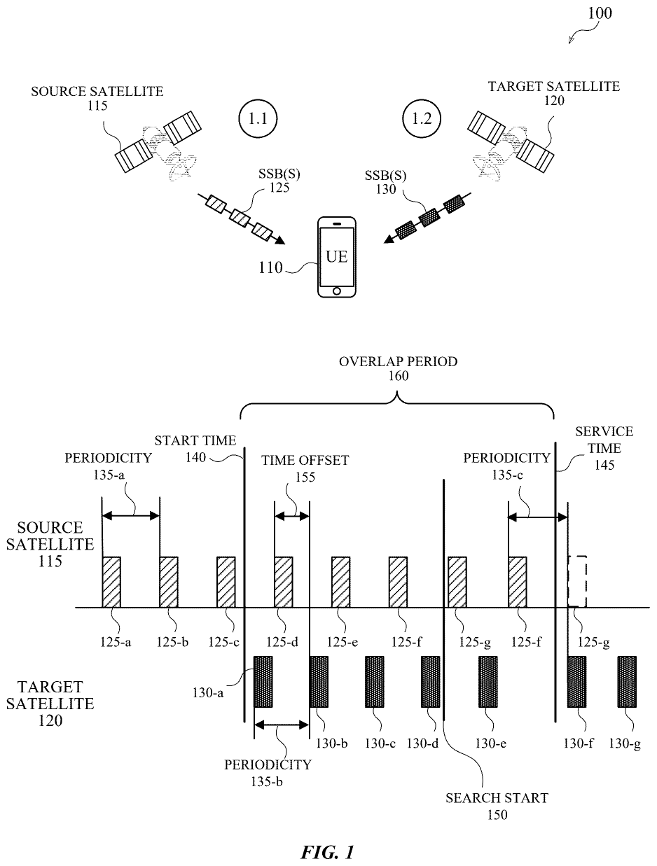

FIG. 1 is a diagram of an example of an overview 100 according to one or more implementations described herein. As shown, overview 100 can include source satellite 115 and target satellite 120 in communicate with UE 110. Source satellite 115 (e.g., serving satellite, satellite 1, old satellite) can be an example of a satellite in communicate with UE 110, and target satellite 120 (e.g., new satellite, satellite 2) can be an example of a satellite that UE 110 can switch to. Source satellite SSBs 125 can be transmitted by source satellite 115, and target satellite SSBs 130 can be transmitted by target satellite 120. In some examples, SSBs 125 and SSBs 130 can be received by UE 110. Operations described as being performed by a UE can be performed, at least in part, by baseband circuitry of UE 110. Operations described as being performed by satellites can be performed, at least in part, by circuitry of the satellites. Techniques described herein are not limited to the number, sequence, arrangement, timing, etc., of the operations or processes depicted in FIG. 1.

In some examples, UE 110 perform satellite switching, such as a soft satellite switching. During soft satellite switching, source satellite 115 coverage and target satellite 120 coverage overlap while UE 110 transfers communications from source satellite 115 to target satellite 120. For example, prior to performing soft satellite switching, UE 110 can receive SSBs 125 from source satellite 115. While performing soft satellite switching and connecting to target satellite 120, UE 110 continues to receive SSBs 125 from source satellite 115 and searches for SSBs 130 from target satellite 120. After performing soft satellite switching, UE 110 can be connected to target satellite 120 (e.g., the new serving satellite) and receive SSBs 130 from target satellite 120 and may no longer receive SSBs 125 from source satellite 115.

UE 110 can initiate soft satellite switching during overlap period 160, after target satellite 120 is serving the area, at start time 140 (e.g., t-ServiceStart), and before source satellite 115 stops serving the area, at service time 145 (e.g., t-Service). To initiate soft satellite switching, UE 110 can begin cell searching for target satellite 120 at search start 150. Cell searching can include searching for a satellite, such as target satellite 120, and receiving information for synchronization, such as SSB(s) 130. To perform soft satellite switching, UE 110 can further perform fine time tracking. Fine time tracking can include determining the location of target satellite 120 in relation to time with a high degree of accuracy. In some examples, UE 110 may or may not complete cell searching, fine time tracking, or both, prior to service time 145.

SSBs 125 and SSBs 130 can have the same periodicity 135. For example, periodicity 135-a of the SSBs 125 and the periodicity 135-b of the SSBs 130 are the same periodicity 135. In some examples, periodicity 135 can be an SSB periodicity or an SSB-based measurement timing configuration (SMTC) periodicity. Additionally, target satellite 120 and source satellite 115 can be a part of the same cell and have the same physical cell identifier (PCI) (e.g., PCI as described at UE 110). To avoid collision, SSBs 125 can be offset from SSBs 130 according to time offset 155. Time offset 155 introduces a temporarily shifted SSB pattern for SSBs 130 during overlap period 160 to prevent collisions.

Once UE 110 switches satellites, that is, once UE 110 has performed soft satellite switching, UE 110 re-synchronizes. At service time 145, (e.g., t-Service), the pattern, or timing, of the target satellite SSBs 130, which are now the new serving satellite SSBs 130, are restored to the same pattern as the previous source satellite SSBs 125. For example, periodicity 315-c shows the same periodicity 315 between SSB 125-f and SSB 130-f, where SSB 125-f is the last SSB of source satellite 115 prior to service time 145 and SSB 130-f is the first SSB of target satellite 120 after service time 145. As shown with respect to FIG. 1, the periodicity between SSB 130-e and SSB 103-f, the last SSB 130 of target satellite 120 prior to service time 145 and the first SSB 130 after service time 145, respectively, can have a longer periodicity than periodicity 135.

To re-synchronize and adjust the pattern of the target satellite SSBs 130, time offset 155 can be adjusted after service time 145. For example, SSB 310-f occurs at the time SSB 125-g would have been received, maintaining the periodicity 315 and reducing time offset 155 to 0. In some examples, time offset 155 can be adjusted based on synchronization information received prior to soft satellite switching. In some examples, timing information acquired prior to service time 145 may or may not be applicable when UE 110 may not have completed cell searching, fine time tracking or both. In some examples, UE 110 can request updated synchronization information.

In some examples, UE 110 can complete cell searching prior to service time 145, or the end of overlap period 160. For example, if X samples of SSBs 130 are used for cell searching, UE 110 can begin cell searching earlier to obtain X samples of SSBs 130 prior to service time 145. For example, when X=1, UE 110 can begin searching at search start 150. UE 110 can sample SSB 130-e prior to service time 145. The number of samples can be preconfigured or otherwise indicated to UE 110 prior to satellite switching.

In some examples, UE 110 may not complete cell searching of target satellite 120 before service time 145. In such examples, various parameters can be adjusted or redefined, such as time offset 155, search time (e.g., T_{search}), and time of the first SSB 130 (e.g., T_{first_SSB}). UE 110 can adjust time offset 155 to a new SSB time offset to search SSBs 130 of target satellite 120 (e.g., adjusted to 0). Search time can be further adjusted according to characteristics of the target cell. The time of the first SSB 130 can be defined as the time to the end of the first complete SSB 130 burst of target satellite 120 (e.g., SSB 130-a to SSB 130-e). When the first SSB 130 is received before service time 145, the location of first SSB 130 is determined by the periodicity 135 and location of SSB 125 of source satellite 115, time offset 155 prior to adjustment (e.g., ssb-TimeOffset), and the difference between propagation delay of the serving satellite (e.g., source satellite 115) and the target satellite 120 counted from an SSB time offset reference point of UE 110 (e.g., SSB-TimeOffset reference point as defined to UE 110).

When the first SSB 130 is received after the end of service time 145 (e.g., SSB 130-f), the location of the first SSB 130 can be determined by periodicity 135 and location of SSB 125 of the source satellite, the new adjusted time offset (e.g., time offset 155 changes back to 0) and the difference between propagation delay of the serving satellite (e.g., source satellite 115) and target satellite 120 counted from a reference point of UE 110. In some examples, the location of the first SSB 130 can be determined by the location of SSB 125 in the SSB-based measurement timing configuration (SMTC) window of source satellite 115 or target satellite 120. The SMTC window offset is configured from the network to UE 110.

In addition to cell searching, UE 110 can perform fine time tracking. Fine time tracking can include determining the location and timing of target satellite 120. UE 110 can complete cell searching and fine time tracking, acquiring full timing information for target satellite 120, prior to the service time 145. In some examples, UE 110 uses samples of SSBs 310 to perform cell searching and fine time tracking. For example, UE 110 can use X+Y samples for cell searching and fine time tracking, where X and Y are numbers of samples, or SSBs 130. In some examples, X can indicate samples for cell searching, and Y can indicate sample for fine time tracking. UE 110 can begin cell searching and fine time tracking earlier to sample X+Y sample of SSBs 130 prior to service time 145. For example, if X=1 and Y=1, UE 110 can begin searching prior to SSB 130-d to have two samples prior to service time 145: SSB 130-d and SSB 130-e.

In some examples, UE 110 may not complete fine time tracking and acquire full timing information of target satellite 120 before service time 145 (e.g., t-Service expiration). In some examples, UE 110 can complete cell searching before service time 145 but may not complete fine time tracking before service time 145. In some examples, the UE may not complete cell searching and fine time tracking before service time 145.

In some examples, when UE 110 may not complete fine time tracking, various parameters can be adjusted or redefined. For example, TΔ can be the time used for fine time tracking and acquiring full timing information of the target cell. If SSB 130 of fine time tracking can be received before service time 145, T_{Δ} is equal to the SMTC periodicity or configuration of the target cell (Tᵣₛ) (e.g., T_{Δ}=Tᵣₛ). Otherwise, if SSB 130 of fine time tracking is received after service time 335, T_{Δ} is equal to the SMTC periodicity or configuration of the target cell and a time adjustment (e.g., T_{Δ}=Tᵣₛ+time-adjustment). In some examples, time adjustment can be defined by the difference between SSB periodicity 135 and time offset 155.

UE 110 can determine the location of target satellite 120 via the location of SSB 130. In some examples, the time-adjustment or the SSB 130 location can be determined by the location of SSB 125 of source satellite 115, the new adjusted time offset (e.g., ssb-TimeOffset), which can change back to 0, and the difference between propagation delay of the serving satellite (e.g., source satellite 115) and target satellite 120 counted from an SSB time offset reference point of UE 110 (e.g., SSB-TimeOffset reference point as defined to UE). In some examples, the time-adjustment or the SSB location for time tracking can be determined by the location of SSB 130 in the SMTC window of the source satellite or the target satellite. The SMTC window offset is configured from network to UE 110.

In some examples, UE 110 can collect samples prior to service time 335 and samples after service time 335. For example, UE 110 can sample SSB 310-e and SSB 310-f. The UE 110 can use samples together for PHY filtering. In some examples, UE 110 can drop the sample before service time 145 and only use the samples after service time 335 for PHY filtering.

In some examples, if UE 110 completes the cell searching but does not complete the fine timing tracking, the time for fine time tracking and acquiring full timing information of the target cell (e.g., TΔ) can be redefined. UE 110 measurement behavior if some samples collected are before service time 335 while other samples are after service time 335 can be further described herein.

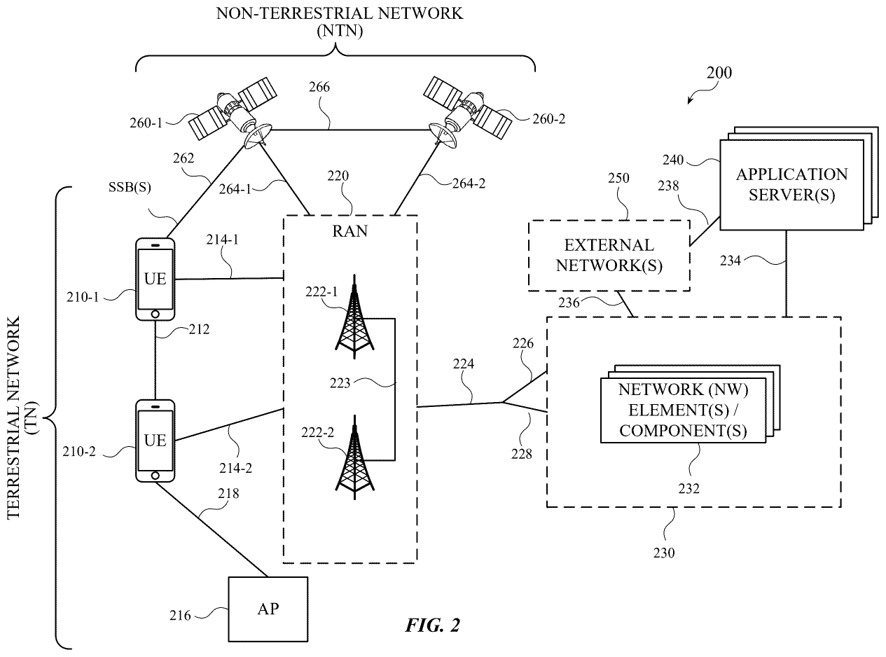

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, external networks 250, and satellites 260-1, 260-2, etc. (referred to collectively as “satellites 260” and individually as “satellite 260”). As shown, network 200 can include a non-terrestrial network (NTN) comprising one or more satellites 260 (e.g., of a global navigation satellite system (GNSS)) in communication with UEs 210 and RAN 220.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IOT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another.

As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection interface 218 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. A RAN node 222 can be a base station and may be referred to herein as a base station. RAN nodes 222 can include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. The RAN nodes 222 can be configured to communicate with the CN 230 via various interfaces, such as physical interfaces, including interface 224, interface 226, and interface 228.

In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VOIP) sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

Satellites 260 can communicate with UEs 210 via service link or wireless interface 262 and/or RAN 220 via feeder links or wireless interfaces 264 (depicted individually as 264-1 and 264-2). In some implementations, satellite 260 can operate as a passive or transparent network relay node regarding communications between UE 210 and the terrestrial network (e.g., RAN 220). In some implementations, satellite 260 can operate as an active or regenerative network node such that satellite 260 can operate as a base station to UEs 210 (e.g., as a base station of RAN 220). In some implementations, satellites 260 can communicate with one another via a direct wireless interface (e.g., 266) or an indirect wireless interface (e.g., via RAN 220 using interfaces 264-1 and 264-2).

One or more of the techniques, described herein, can enable UE 210 to perform satellite switching with SSB offset transition without PCI change. For example, UE 210 can receive SSBs from satellites 260, such as a source satellite and a target satellite. In some examples, UE 210 can perform satellite switching from the source satellite to the target satellite, including cell searching and fine time tracking. In some examples, UE 210 can complete cell searching, or cell searching and fine time tracking, prior to the expiration of a coverage overlap period of the target satellite and source satellite. UE 210 can begin cell searching and fine time tracking earlier to obtain the necessary samples of SSBs from the target base station prior to the expiration of the coverage overlap period. After the coverage overlap, the time offset can be adjusted. In some examples, UE 210 may not complete cell searching, fine time tracking, or both, prior to the service time. In such examples, synchronization information, such as time offset and search time, can be adjusted. For example, time offset and search time can be adjusted. UE 210 can determine the location of the first SSB of the target satellite using timing information based on whether the SSB was received prior to the service time or after the service time. These and many other features and aspects of the techniques described herein are presented below with reference to remaining Figures.

Additionally, or alternatively, satellite 260 may include a GEO satellite, LEO satellite, or another type of satellite. Satellite 260 may also, or alternatively pertain to one or more satellite systems or architectures, such as a global navigation satellite system (GNSS), global positioning system (GPS), global navigation satellite system (GLONASS), BeiDou navigation satellite system (BDS), etc. In some implementations, satellites 260 may operate as bases stations (e.g., RAN nodes 222) with respect to UEs 210. As such, references herein to a base station, RAN node 222, etc., may involve implementations where the base station, RAN node 222, etc., is a terrestrial network node and implementation, where the base station, RAN node 222, etc., is a non-terrestrial network node (e.g., satellite 260). As described herein, UE 210 and base station may communicate with one another, via interface 214, to enable enhanced power saving techniques.

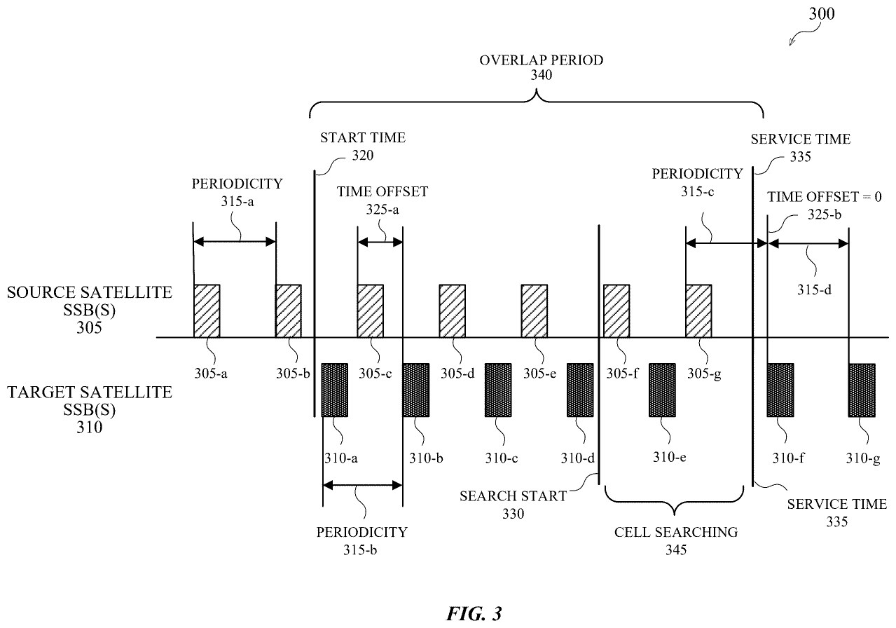

FIG. 3 is a diagram of an example of transmission timeline 300 for SSB offset transition of satellite switching according to one or more implementations described herein. As shown, transmission timeline 300 can include source satellite SSBs 305 (e.g., SSB transmissions) and target satellite SSBs 310 (e.g., SSB transmissions). Source satellite SSBs 305 can be transmitted by a source satellite, and target satellite SSBs 310 can be transmitted by a target satellite. Source satellites (e.g., serving satellite, satellite 1, old satellite) and target satellites (e.g., new satellite, satellite 2) can be examples of satellites, such as satellites 260 as described with reference to FIG. 2. In some examples, SSBs 305 and SSBs 310 can be received by a UE, such as UE 210, as described with reference to FIG. 2. Operations described as being performed by a UE can be performed, at least in part, by baseband circuitry of UE 110. Operations described as being performed by satellites can be performed, at least in part, by circuitry of the satellites. Techniques described herein are not limited to the number, sequence, arrangement, timing, etc., of the operations or processes depicted in FIG. 3.

In some examples, a UE can perform a soft satellite switching without PCI change. During soft satellite switching, source satellite coverage and target satellite coverage overlap while the UE transfers communications from the source satellite to the target satellite. For example, prior to performing soft satellite switching, the UE can receive SSBs 305 from the source satellite. While performing soft satellite switching and connecting to the target satellite, the UE continues to receive SSBs 305 from the source satellite.

Soft satellite switching can include cell searching and fine time tracking of the target cell. The UE can initiate the procedure during overlap period 340. Overlap period 340 can include after the target satellite starts serving the same area, at start time 320, (e.g., t-ServiceStart) and before the source satellite stops serving the area, at service time 335 (e.g., t-Service).

In some examples, periodicity 315-a of the SSBs 305 and the periodicity 315-b of the SSBs 310 are the same periodicity 315. In some examples, periodicity 315 is an SSB periodicity 315. In some examples, the periodicity 315 is an SMTC periodicity. Additionally, the target satellite and source satellite can be a part of the same cell and have the same physical cell identifier (PCI) at the UE. In some examples, the UE can perform satellite switching with re-synchronization, where the PCI at the UE, the SSB frequency of the satellite switching, and the gNB remains the same, without layer 3 (L3) mobility movement.

Once the UE switches satellites, that is, one the UE has performed soft satellite switching (e.g., during overlap period 340), the UE re-synchronizes. At service time 335, (e.g., t-Service), the pattern, or timing, of the target satellite SSBs 310, which are now the new serving satellite SSBs 310, are restored to the same as the previous source satellite SSBs 305. For example, periodicity 315-c shows the same periodicity 315 between the last SSB 305-g of the source satellite and the following SSB 310-f of the target satellite. SSB 310-f occurs at the time the first SSB 305 after service time 335 would have been received, maintaining the periodicity 315 and reducing time offset 325-b to 0.

For soft satellite switching with re-synchronization, to ensure that SSBs 305 and SSBs 310, having the same periodicity 315, frequency, and PCI at the UE side, avoid collision, SSBs 310 are offset from SSBs 305 according to time offset 325. Time offset 325 introduces a temporarily shifted SSB pattern for SSBs 310 during overlap period 340 to prevent collisions.

The shift due to the time offset 325 shifts the SSBs 310, maintaining the pattern of SSBs 305, while both SSBs 305 and SSBs 310 have the same periodicity 315. For example, periodicity 315-a describes the time between SSB 305-a and SSB 305-b of the source satellite. Periodicity 315-a is the same as periodicity 315-b, which describes the time between SSB 310-a and SSB 310-b of the target satellite. Time offset 325-a is an example of the time offset between each SSB 305 and SSB 310 during the overlap period, such as between SSB 305-c and SSB 310-b.

Prior to beginning soft satellite switching, the UE can receive satellite switching information, which can include downlink synchronization information, such as a system information block (SIB), for synchronization during and after overlap period 340. In some examples, the time offset 325 (e.g., SSB offset), which sets the SSB pattern, can be changed at service time 335. For example, prior to service time 335, the time offset 325-a is non-zero, and after service time 335, the time offset 325-b is 0. The change to the time offset 325 can result in a change to the downlink synchronization information. In some examples, the pre-acquired downlink synchronization can remain the same after service time 335, and in some examples, can change. In some examples, the UE can request updated downlink synchronization information.

In some examples, timing information acquired prior to service time 335 can be used after service time 335 for the target satellite. In some examples, the UE may not complete timing acquisition prior to service time 335. In some examples, the UE can collect measurements prior to service time 335 and after service time 335. Techniques, methods, and descriptions herein provide for UE behavior for scenarios when timing is acquired before service time 335 or after service time 335, and scenarios where measurements are collected before and after service time 335, among other examples.

The time for the UE to perform soft satellite switching can be based on start time 320, service time 335, the time used to search for the target satellite during cell searching 345, the time used for fine time tracking, the time used for acquiring timing information of the target cell, processing time, SSB transmission time, and error margins, among other factors. To perform soft satellite switching, the UE can perform cell searching and fine time tracking. Cell searching can include searching for a satellite, such as a target satellite, and receiving information for synchronizing with the applicable satellite, such as SSB 310. Fine time tracking can include determining the location of the target satellite in relation to time with a high degree of accuracy. In some examples, the UE may not complete cell searching when service time 335 expires, or by the end of overlap period 340. In some examples, the UE may not complete cell searching prior to the end of the overlap period 340.

In some examples, such as if UE cannot complete the cell searching before service time 335, the first SSB for cell searching 345 can be defined. In some examples, if UE completes the cell searching 345 but does not complete the timing tracking, the time for fine time tracking and acquiring full timing information of the target cell (e.g., TΔ) can be redefined. UE measurement behavior if some samples collected are before service time 335 while other samples are after service time 335 can be further described herein.

In some examples, the UE can complete cell searching prior to the service time 335, or the end of overlap period 340. For example, if X samples of SSBs are used for cell searching, the UE can begin cell searching earlier to obtain X samples of SSBs prior to service time 335 (e.g., before the target satellite SSB time offset 325 is changed back to 0). For example, when X=1, UE can begin searching at search start 330. UE can sample SSB 310-e prior to service time 335. When X=2, for example, UE can begin searching prior to SSB 310-d, and sample SSB 310-d and SSB 310-e prior to service time 335. The number of samples can be preconfigured or otherwise indicated to the UE prior to satellite switching.

In some examples, UE may not complete cell searching 345 of the target satellite before service time 335. In such examples, UE can change to search the SSBs 310 of the target satellite with a new SSB time offset 325-b. As described with reference to FIG. 3, time offset 325-b is adjusted to 0. The search time (e.g., T_{search}) can be the time required to search the target NR SAN cell (e.g., NR standalone (SAN) cell) when the target is not already known when the handover command is received by the UE. In some examples, the target satellite can be a part of the target cell. When the target cell has a ratio of embedded systems(ES) to IoT that is greater than −2 dB, then the search time is equal to the time of the first SSB 310 in milliseconds. (e.g., if Es/Iot≥−2 dB, then T_{search}=T_{first_SSB} ms).

The time of the first SSB 310 set can be the time to the end of the first complete SSB 310 burst of the target satellite (e.g., SSB 310-a to SSB 310-e). When the first SSB 310 is received before service time 335, the location of first SSB 310 is determined by the periodicity 315 and location of SSB 305 of the source satellite, the time offset 325-a (e.g., ssb-TimeOffset) and the difference between propagation delay of the serving satellite (e.g., source satellite) and the target satellite counted from an SSB time offset reference point of the UE (e.g., SSB-TimeOffset reference point as defined to UE).

When the first SSB 310 is received after the end of service time 335 (e.g., SSB 310-f), the location of the first SSB 310 can be determined by the periodicity and location of SSB 305 of the source satellite, the new adjusted time offset 325-b (e.g., time offset 325-b changes back to 0) and the difference between propagation delay of the serving satellite (e.g., source satellite) and the target satellite counted from a reference point of the UE.

In some examples, when the first SSB 310 is received after the end of service time 335 (e.g., SSB 310-f), the location of the first SSB 310 can be determined by the location of SSB 305 of the source satellite, and the difference between propagation delay of the serving satellite (e.g., source satellite) and the target satellite from the reference point of the UE. The UE can determine the location of the first SSB 310 of the target satellite based on arrival time and propagation delay difference between source satellite SSB 305 and target satellite SSB 310 (e.g., calculated from UE location and satellite ephemeris information).

In some examples, when the first SSB 310 is receive after the end of service time 335 (e.g., SSB 310-f), the location of the first SSB 310 can be determined by the location of the SSB 305 in the SSB-based measurement timing configuration (SMTC) window of the source satellite or the target satellite. The SMTC window offset is configured by the network to the UE.

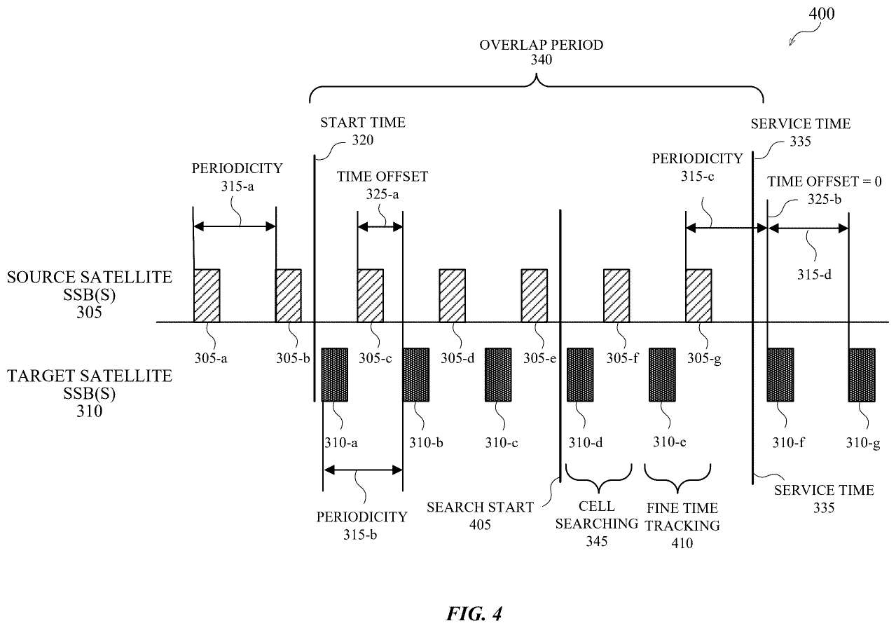

FIG. 4 is a diagram of an example of transmission timeline 400 for SSB offset transition of satellite switching according to one or more implementations described herein. As shown, transmission timeline 400 can include source satellite SSBs 305 (e.g., SSB transmissions) and target satellite SSBs 310 (e.g., SSB transmissions). Source satellite SSBs 305 can be transmitted by a source satellite, and target satellite SSBs 310 can be transmitted by a target satellite. Source satellites (e.g., serving satellite, satellite 1, old satellite) and target satellites (e.g., new satellite, satellite 2) can be examples of satellites, such as satellites 260 as described with reference to FIG. 2.

In some examples, SSBs 305 and SSBs 310 can be received by a UE, such as UE 210 as described with reference to FIG. 2. Operations described as being performed by a UE can be performed, at least in part, by baseband circuitry of UE 110. Operations described as being performed by satellites can be performed, at least in part, by circuitry of the satellites. Techniques described herein are not limited to the number, sequence, arrangement, timing, etc., of the operations or processes depicted in FIG. 4. FIG. 4 can be another example as related to FIG. 3. In some examples, periodicity 315 is an SSB periodicity 315. In some examples, the periodicity 315 is an SMTC periodicity.

UE can perform fine time tracking 410. Fine time tracking 410 can include determining the location and timing of the target satellite. The UE can complete cell searching 345 and fine time tracking 410, acquiring full timing information for the target satellite, prior to the service time 335. In some examples, the UE uses samples of SSBs 310 to perform cell searching 345 and fine time tracking 410. For example, UE can use X+Y samples for cell searching, where X and Y are numbers of samples, or SSBs 310. The UE can begin cell searching 345 and fine time tracking 410 earlier to sample X+Y sample of SSBs 310 prior to service time 335, when the time offset 325-b is 0. In some examples, X samples can be applied to cell searching and Y samples can be applied to fine time tracking 410. For example, if X=1 and Y=1, the UE can begin searching at search start 405 to have two samples prior to service time 335: SSB 310-d and SSB 310-e.

In some examples, the UE may not complete fine time tracking 410 and acquire full timing information of the target satellite before service time 335 (e.g., t-Service expiration). The UE can change to tracking the target timing with the new time offset 325-b, where the offset is 0. In some examples, the UE can complete cell searching before service time 335 but may not complete fine time tracking 410 before service time 335. In some examples, the UE may not complete cell searching and fine time tracking 410 before service time 335.

TΔ can be the time used for fine time tracking 410 and acquiring full timing information of the target cell. In some examples, determining the location of SSB 310 can indicate the location of the target satellite. If the SSB 310 of fine time tracking 410 can be received before service time 335, T_{Δ} is equal to the SMTC periodicity or configuration of the target cell (e.g., T_{Δ}=Tᵣₛ). Otherwise, if the SSB 310 of time tracking can be received after service time 335, T_{Δ} is equal to the SMTC periodicity or configuration of the target cell and a time adjustment (e.g., T_{Δ}=Tᵣₛ+time-adjustment).

In some examples, time adjustment can be defined by the difference between the SSB periodicity 315 and the time offset 325 (e.g., ssb-TimeOffset), such T_{Δ} that can be equal to the difference between 2*SSB periodicity 315 and time offset 325. That is: in some examples, T_{Δ}=Tᵣₛ+time-adjustment; Time adjustment can be (SSB periodicity−ssb-TimeOffset); and therefore T_{Δ}=Tᵣₛ+(SSB periodicity−ssb-TimeOffset)=SSB periodicity+SSB periodicity−ssb-TimeOffset=2* SSB periodicity−ssb-TimeOffset.

In some examples, the time-adjustment or the SSB location for time tracking can be determined by: location of SSB 305 of the source satellite, the new adjusted time offset 325-a (e.g., ssb-TimeOffset), which can change back to 0, and the difference between propagation delay of the serving satellite (e.g., source satellite) and the target satellite counted from an SSB time offset reference point of the UE (e.g., SSB-TimeOffset reference point as defined to UE).

In some examples, the time adjustment or the SSB location for time tracking can be determined by the location of SSB 305 of the source satellite, the difference between propagation delay of the serving satellite (e.g., source satellite) and the target satellite from a reference point as defined to the UE. The UE can determine the location of the first SSB 310 of the target satellite based on arrival time and propagation delay difference between source satellite SSB 305 and target satellite SSB 310 (e.g., calculated from UE location and satellite ephemeris information).

In some examples, the time-adjustment or the SSB location for time tracking can be determined by the location of SSB in the SMTC window of the source satellite or the target satellite. The SMTC window offset is configured from network to UE.

In some examples, the UE can complete cell searching before service time 335 but may not complete fine time tracking before service time 335. In such examples, TΔ is the time uncertainty, or a time delay margin, to receive the first Y SSBs 310 after service time 335. For example, if Y=1, then TΔ is the time uncertainty, or a time delay margin, to receive SSBs 310-f. In some examples, the UE may not complete cell searching and fine time tracking before service time 335. In such examples, TΔ is the time uncertainty, or a time delay margin, to receive the first X+Y SSBs 310 after service time 335. For example, if X=1 and Y=1 in this example, the first X+Y SSBs 310 are SSB 310-f and SSB 310-g.

In some examples, the UE can collect samples prior to service time 335 and samples after service time 335. For example, the UE can sample SSB 310-e and SSB 310-f. The UE can use samples together for PHY filtering. The measurement period can be represented by the sample number, periodicity 315, and time adjustment (e.g., sample_number*SSB_periodicity+time-adjustment). The time adjustment can be the difference between periodicity 315 and time offset 325 (e.g., SSB periodicity−ssb-TimeOffset). In some examples, UE can drop the sample before service time 335 and only use the samples after service time 335 for PHY filtering.

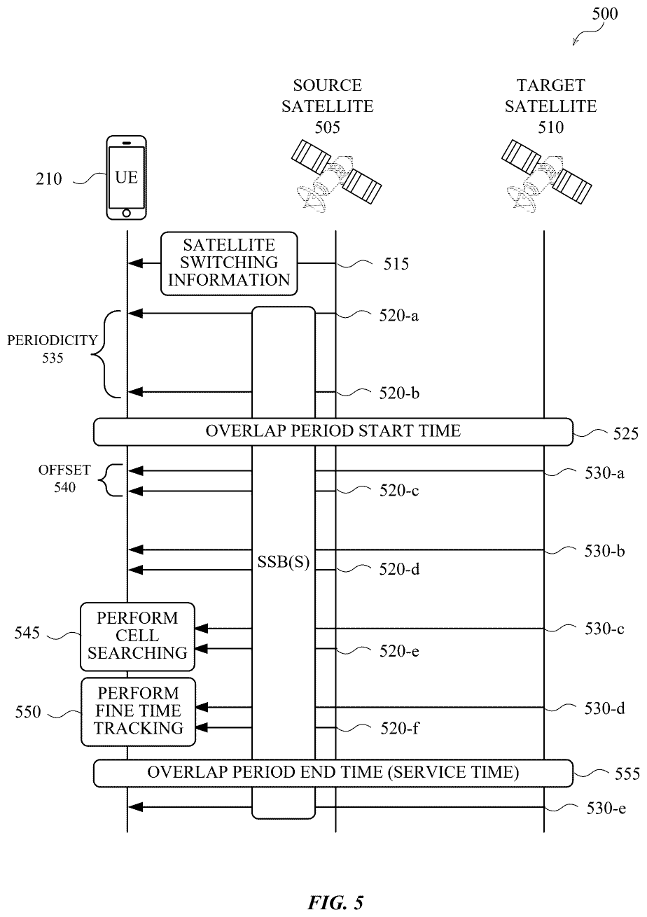

FIG. 5 is a diagram of an example of process 500 for SSB offset transition of satellite switching according to one or more implementations described herein. As shown, process 500 be performed by UE 210, source satellite 505, and target satellite 510. Source satellite 505 and target satellite 510 can be examples of satellites, such as satellites 260 as described with reference to FIG. 2. Operations described as being performed by UE 210 can be performed, at least in part, by baseband circuitry of UE 210. Some or all of process 500 can be performed by one or more other systems or devices, including one or more of the devices of FIG. 2.

Additionally, process 500 can include one or more fewer, additional, differently ordered, and/or arranged operations than those shown in FIG. 5. Some or all of the operations of process 500 can be performed independently, successively, simultaneously, etc., of one or more of the other operations of process 300. As such, the techniques described herein are not limited to the number, sequence, arrangement, timing, etc., of the operations or processes depicted in FIG. 5.

As shown, process 500 can include communicating satellite switching information (at 515). For example, UE 210 can receive satellite switching information from source satellite 505. In some examples, satellite switching information can be received form a network entity, base station, or gNB, or otherwise configured at UE 210. Satellite switching information can include an SSB transmission time offset, start and end times for satellite switching (e.g., service time start, service time end), whether the satellite switching is soft or hard satellite switching, SSB information, etc. In some examples, satellite switching information can be part of a system information block (SIB).

In some examples, satellite switching information can include downlink synchronization information, such as a system information block (SIB), for synchronization during and after the time period between the overlap period start time and overlap period end time (e.g., service time). The overlap period can be the time period between the service start time and service end time. In some examples, the time offset 540 (e.g., SSB offset, SMTC offset) can set the SSB pattern, and can be changed at the end of the overlap period (e.g., at the service time). The change to the time offset can result in a change to the downlink synchronization information. In some examples, the pre-acquired downlink synchronization can remain the same after service time, and in some examples, can change. In some examples, the UE can request updated downlink synchronization information.

Process 500 can also include source satellite 505 transmitting SSBs (at 520-a and 520-b). For example, source satellite 505 can transmit SSBs to UE 210. The time between SSBs is periodicity 535.

Process 500 can include an overlap period start time (at 525). For example, coverage overlap between source satellite 505 and target satellite 510 can begin at the overlap period start time (e.g., t-ServiceStart) and end at the overlap period end time (service time). During the overlap period, UE 210 can initiate soft satellite switching.

Process 500 can include source satellite 505 and target satellite 510 transmission SSBs (at 520 and 530). For example, after the service start time, source satellite 505 can continue transmitting SSBs (at 520-c, 520-d, 520-e, and 520-f) with the same periodicity 535 as prior to the service start time. Target satellite 510 can also begin transmitting SSBs with the same frequency and periodicity 535 (at 530-a, 530-b, 530-d, 530-d), according to time offset 325.

Process 500 can include performing cell searching (at 545). For example, UE 210 can perform cell searching. Cell searching can include searching for a satellite, such as a target satellite 510, and receiving information for synchronizing with that satellite, such as SSB 310. In some examples, UE 210 can complete cell searching prior to the end of the overlap period. For example, UE 210 can sample SSB 530-c, SSB 530-d, or both, based on sample needs.

In some examples, UE 210 may not complete cell searching before the end of the overlap period. In such examples, UE 210 adjust time offset 540 to a new SSB time offset, and search for SSBs of target satellite 510 based on the new offset. UE 210 can also adjust other parameters, such as search time. In some examples, UE 210 can begin cell searching, but may not complete cell searching, prior to the end of the overlap time period. In such examples, location determination parameters of the SSB of target satellite 510 can be redefined.

Process 500 can include performing fine time tracking (at 550). For example, the UE can perform fine time tracking. Fine time tracking can include determining the location and timing of target satellite 510, such as based on a location of the SSB of target satellite 510. In some examples, UE 210 can complete cell searching and fine time tracking, acquiring full timing information for the target satellite, prior to the service time. In some examples, UE 210 uses samples of SSBs to perform cell searching 345 and fine time tracking 410. UE 210 can sample SSBs, such as SSB 530-c, SSB 530-d, or both, based on sample needs.

In some examples, UE 210 may not complete fine time tracking and acquire full timing information of the target satellite before service time. In such example, UE 210 can adjust time offset 540 to a new time offset, and search for SSBs of target satellite 510 accordingly. Further, location of target satellite 510 can be determined based on adjusted or redefined parameters. For example, the time-adjustment or the SSB location for time tracking can be determined by the location of SSBs of source satellite 505, the difference between propagation delay of the old serving satellite (e.g., source satellite 505) and new serving satellite (e.g., target satellite 510) from a reference point, and arrival time, or a combination hereof.

Process 500 can include overlap period end time (e.g., service time) (at 555). For example, the overlap period can end at the overlap period end time (e.g., service time). At the end of the overlap period, UE 210 can adjust time offset 540 to shift the SSB pattern of target satellite 510, such as by changing time offset 540 to 0. Target satellite 510 can transmit SSBs (e.g., SSB 530-e) to UE 210. In some examples, such as if UE 210 has successfully performed cell searching and fine time tracking, UE 210 can have switched to target satellite 510, and can receive SSB 530-e, and subsequent SSBs, accordingly. In some examples, if UE 210 has not successfully performed cell searching, fine time tracking, or both, UE 210 can sample SSB 530-e as part of satellite switching.

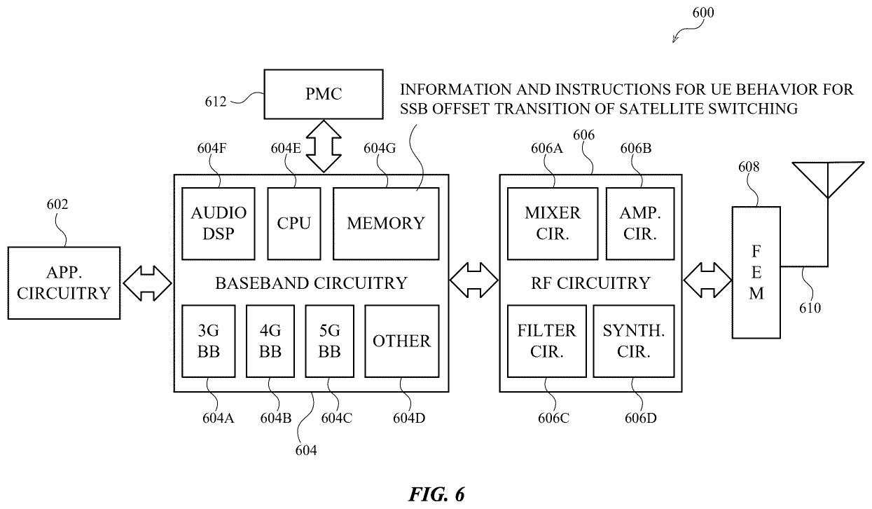

FIG. 6 is a diagram of an example of components of a device according to one or more implementations described herein. In some implementations, the device 600 can include application circuitry 602, baseband circuitry 604, RF circuitry 606, front-end module (FEM) circuitry 608, one or more antennas 610, and power management circuitry (PMC) 612 coupled together at least as shown. In some implementations, device 600 can include fewer elements (e.g., a RAN node may not utilize application circuitry 602 and can instead include a processor/controller to process data received from a core network. In some implementations, device 600 can include additional elements such as, for example, memory/storage, display, camera, sensor (including one or more temperature sensors, such as a single temperature sensor, a plurality of temperature sensors at different locations in device 600, etc.), or input/output (I/O) interface. In other implementations, the components described below can be included in more than one device (e.g., said circuitries can be separately included in more than one device for cloud-RAN (C-RAN) implementations).

The application circuitry 602 can include one or more application processors. For example, the application circuitry 602 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 600. In some implementations, processors of application circuitry 602 can process data packets received from a core network.

The baseband circuitry 604 can include circuitry such as, but not limited to, one or more single-core or multi-core processors. Baseband circuitry 604 can include one or more baseband processors or control logic to process baseband signals received from a receive signal path of RF circuitry 606 and to generate baseband signals for a transmit signal path of RF circuitry 606. Baseband circuitry 604 can interface with application circuitry 602 for generation and processing of the baseband signals and for controlling operations of RF circuitry 606. For example, in some implementations, baseband circuitry 604 can include a 3G baseband processor 604A, a 4G baseband processor 604B, a 5G baseband processor 604C, or other baseband processor(s) 604D for other existing generations, generations in development or to be developed in the future (e.g., 5G, 6G, 7G, etc.). Baseband circuitry 604 (e.g., one or more of baseband processors 604A-604D) can handle various radio control functions that enable communication with one or more radio networks via RF circuitry 606. In other implementations, some or all of the functionality of baseband processors 604A-604D can be included in modules stored in memory 604G and executed via a central processing unit (CPU) 604E. The radio control functions can include, but are not limited to, signal modulation/demodulation, encoding/decoding, radio frequency shifting, etc. In some implementations, modulation/demodulation circuitry of baseband circuitry 604 can include Fast-Fourier Transform (FFT), precoding, or constellation mapping/de-mapping functionality. In some implementations, encoding/decoding circuitry of baseband circuitry 604 can include convolution, tail-biting convolution, turbo, Viterbi, or low-density parity check (LDPC) encoder/decoder functionality. Implementations of modulation/demodulation and encoder/decoder functionality are not limited to these examples and can include other suitable functionality in other implementations.

In some implementations, memory 604G can receive and/or store information and instructions for enabling UE 210, and/or one or more components thereof, to perform satellite switching with SSB offset transition without PCI change. For example, the information and instructions can cause and/or enable UE 210 to receive SSBs from satellites, such as a source satellite and a target satellite. In some examples, UE 210 can perform satellite switching from the source satellite to the target satellite, including cell searching and fine time tracking. In some examples, UE 210 can complete cell searching, or cell searching and fine time tracking, prior to the expiration of a coverage overlap period of the target satellite and source satellite. After the coverage overlap period, a time offset can be adjusted. In some examples, UE 210 may not complete cell searching, fine time tracking, or both, prior to the service time. In such examples, synchronization information, such as time offset and search time, can be adjusted. UE 210 can determine the location of the first SSB of the target satellite using timing information and based on whether the SSB was received prior to the service time or after the service time. These and many other features and examples are described herein.

In some implementations, the baseband circuitry 604 can include one or more audio digital signal processor(s) (DSP) 604F. The audio DSPs 604F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 604 and the application circuitry 602 can be implemented together such as, for example, on a system on a chip (SOC).

In some implementations, the baseband circuitry 604 can provide for communication compatible with one or more radio technologies. For example, in some implementations, the baseband circuitry 604 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 604 is configured to support radio communications of more than one wireless protocol can be referred to as multi-mode baseband circuitry.

RF circuitry 606 can enable communication with wireless networks using modulated electromagnetic radiation through a non-solid medium. In various implementations, RF circuitry 806 can include switches, filters, amplifiers, etc., to facilitate the communication with the wireless network. RF circuitry 606 can include a receive signal path which can include circuitry to down-convert RF signals received from FEM circuitry 608 and provide baseband signals to baseband circuitry 604. RF circuitry 606 can also include a transmit signal path which can include circuitry to up-convert baseband signals provided by baseband circuitry 604 and provide RF output signals to FEM circuitry 608 for transmission.

In some implementations, the receive signal path of the RF circuitry 606 can include mixer circuitry 606A, amplifier circuitry 606B and filter circuitry 606C. In some implementations, the transmit signal path of RF circuitry 606 can include filter circuitry 606C and mixer circuitry 606A. RF circuitry 606 can also include synthesizer circuitry 606D for synthesizing a frequency for use by mixer circuitry 606A of the receive signal path and the transmit signal path. In some implementations, mixer circuitry 606A of the receive signal path can be configured to down-convert RF signals received from FEM circuitry 608 based on the synthesized frequency provided by synthesizer circuitry 606D. Amplifier circuitry 606B can be configured to amplify the down-converted signals and filter circuitry 606C can be a low-pass filter (LPF) or band-pass filter (BPF) configured to remove unwanted signals from the down-converted signals to generate output baseband signals. Output baseband signals can be provided to baseband circuitry 604 for further processing. In some implementations, the output baseband signals can be zero-frequency baseband signals, although this may not be a requirement. In some implementations, mixer circuitry 606A of the receive signal path can comprise passive mixers, although the scope of the implementations is not limited in this respect.

In some implementations, the mixer circuitry 606A of the transmit signal path can be configured to up-convert input baseband signals based on the synthesized frequency provided by the synthesizer circuitry 606D to generate RF output signals for the FEM circuitry 608. The baseband signals can be provided by the baseband circuitry 604 and can be filtered by filter circuitry 606C.

In some implementations, mixer circuitry 606A of the transmit signal path can be configured to up-convert input baseband signals based on the synthesized frequency provided by synthesizer circuitry 606D to generate RF output signals for FEM circuitry 608. The baseband signals can be provided by baseband circuitry 604 and can be filtered by filter circuitry 606C. In some implementations, mixer circuitry 606A of the receive signal path and mixer circuitry 606A of the transmit signal path can include two or more mixers and can be arranged for quadrature down conversion and up conversion, respectively. In some implementations, mixer circuitry 606A of the receive signal path and mixer circuitry 606A of the transmit signal path can include two or more mixers and can be arranged for image rejection. In some implementations, mixer circuitry 606A of the receive signal path and mixer circuitry 606A can be arranged for direct down conversion and direct up conversion, respectively. In some implementations, mixer circuitry 606A of the receive signal path and mixer circuitry 606A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, RF circuitry 606 can include analog-to-digital converter (ADC) and digital-to-analog converter (DAC) circuitry and baseband circuitry 604 can include a digital baseband interface to communicate with RF circuitry 606.

In some dual-mode implementations, a separate radio IC circuitry can be provided for processing signals for each spectrum, although the scope of the implementations is not limited in this respect. In some implementations, the synthesizer circuitry 606D can be a fractional-N synthesizer or a fractional N/N+1 synthesizer, although the scope of the implementations is not limited in this respect as other types of frequency synthesizers can be suitable. For example, synthesizer circuitry 606D can be a delta-sigma synthesizer, a frequency multiplier, or a synthesizer comprising a phase-locked loop with a frequency divider.

Synthesizer circuitry 606D can be configured to synthesize an output frequency for use by mixer circuitry 606A of RF circuitry 606 based on a frequency input and a divider control input. In some implementations, synthesizer circuitry 606D can be a fractional N/N+1 synthesizer. In some implementations, frequency input can be provided by a voltage-controlled oscillator (VCO). Divider control input can be provided by either baseband circuitry 604 or the applications circuitry 602 depending on the desired output frequency. In some implementations, a divider control input (e.g., N) can be determined from a look-up table based on a channel indicated by the applications circuitry 602.

Synthesizer circuitry 606D of RF circuitry 606 can include a divider, a delay-locked loop (DLL), a multiplexer, and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 606D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, RF circuitry 606 can include an in-phase/quadrature (I/Q)/polar converter.

FEM circuitry 608 can include a receive signal path which can include circuitry configured to operate on RF signals received from one or more antennas 610, amplify the received signals and provide the amplified versions of the received signals to RF circuitry 606 for further processing. FEM circuitry 608 can also include a transmit signal path which can include circuitry configured to amplify signals for transmission provided by RF circuitry 606 for transmission by one or more of the one or more antennas 610. In various implementations, the amplification through the transmit or receive signal paths can be done solely in RF circuitry 606, solely in FEM circuitry 608, or in both RF circuitry 606 and FEM circuitry 608.

In some implementations, the FEM circuitry 608 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 606). The transmit signal path of the FEM circuitry 608 can include a power amplifier (PA) to amplify input RF signals (e.g., provided by RF circuitry 606), and one or more filters to generate RF signals for subsequent transmission (e.g., by one or more of the one or more antennas 610).

In some implementations, the PMC 612 can manage power provided to the baseband circuitry 604. In particular, PMC 612 can control power-source selection, voltage scaling, battery charging, or direct current (DC) to DC (DC-to-DC) conversion. PMC 612 can often be included when device 600 is capable of being powered by a battery, for example, when device 600 is included in a UE. PMC 612 can increase the power conversion efficiency while providing desirable implementation size and heat dissipation characteristics.

While FIG. 6 shows PMC 612 coupled only with the baseband circuitry 604, in other implementations, PMC 612 can be additionally or alternatively coupled with, and perform similar power management operations for, other components such as, but not limited to, application circuitry 602, RF circuitry 606, or FEM circuitry 608.

In some implementations, the PMC 612 can control, or otherwise be part of, various power saving mechanisms of device 600. For example, if device 600 is in an RRC_Connected state, where device 600 is still connected to the RAN node as device 600 expects to receive traffic shortly, then device 600 can enter a state known as discontinuous reception mode (DRX) after a period of inactivity. During this state, device 600 can power down for brief intervals of time and thus save power.

If there is no data traffic activity for an extended period of time, then device 600 can transition off to an RRC_Idle state, where device 600 disconnects from the network and does not perform operations such as channel quality feedback, handover, etc. Device 600 can go into a very low power state and device 600 can perform paging where again device 600 periodically can wake up to listen to the network and then power down again. Device 600 may not receive data in this state; in order to receive data, device 600 can transition back to RRC_Connected state.

An additional power saving mode can allow a device to be unavailable to the network for periods longer than a paging interval (ranging from seconds to a few hours). During this time, the device 600 can be unreachable to the network and can power down completely. Any data sent during this time can incur a large delay and device 600 can assume the delay is acceptable.

Processors of application circuitry 602 and processors of baseband circuitry 604 can be used to execute elements of one or more instances of a protocol stack. For example, processors of baseband circuitry 604, alone or in combination, can be used execute Layer 3, Layer 2, or Layer 1 functionality, while processors of baseband circuitry 604 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control layer. As referred to herein, Layer 2 can comprise a medium access control layer, a radio link control layer, and a packet data convergence protocol layer, described in further detail below. As referred to herein, Layer 1 can comprise a physical layer of a UE/RAN node.

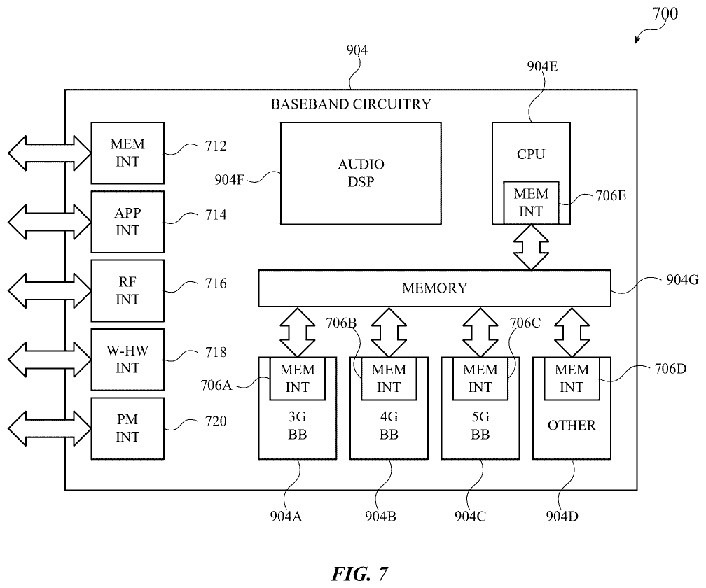

FIG. 7 is a diagram of example interfaces 700 of baseband circuitry according to one or more implementations described herein. One or more components or features of example interfaces 700 can correspond to one or more components or features described above or elsewhere. Baseband circuitry 704 can comprise processors 704A, 704B, 704C, 704D, and 704E and a memory 704G utilized by said processors. Each of the processors 704A, 704B, 704C, 704D, and 704E can include a memory interface, 706A, 706B, 706C, 706D, and 706E, respectively, to send/receive data to/from the memory 704G. Baseband circuitry can be a component of a UE and/or another type of device or system capable of transmitting and/or receiving wireless signals.

In some implementations, memory 704G can receive, store, and/or provide information and instructions for performing satellite switching with SSB offset transition without PCI change. For example, 704G can receive, store, and/or provide information and instructions for enabling UE to receive SSBs from satellites, such as a source satellite and a target satellite. In some examples, UE 210 can perform satellite switching from the source satellite to the target satellite, including cell searching and fine time tracking. In some examples, UE can complete cell searching, or cell searching and fine time tracking, prior to the expiration of a coverage overlap period of the target satellite and source satellite. After the coverage overlap period, a time offset can be adjusted. In some examples, UE may not complete cell searching, fine time tracking, or both, prior to the service time. In such examples, synchronization information, such as time offset and search time, can be adjusted. UE can determine the location of the first SSB of the target satellite using timing information and based on whether the SSB was received prior to the service time or after the service time. These and many other features and examples are described herein.

Baseband circuitry 704 can further include one or more interfaces to communicatively couple to other circuitries/devices, such as a memory interface 712 (e.g., an interface to send/receive data to/from memory external to baseband circuitry 704), an application circuitry interface 714 (e.g., an interface to send/receive data to/from the application circuitry as described herein), an RF circuitry interface 716, a wireless hardware connectivity interface 718 (e.g., an interface to send/receive data to/from Near Field Communication (NFC) components, Bluetooth® components (e.g., Bluetooth® Low Energy), Wi-Fi® components, and other communication components), and a power management interface 720 (e.g., an interface to send/receive power or control signals to/from a PMC).

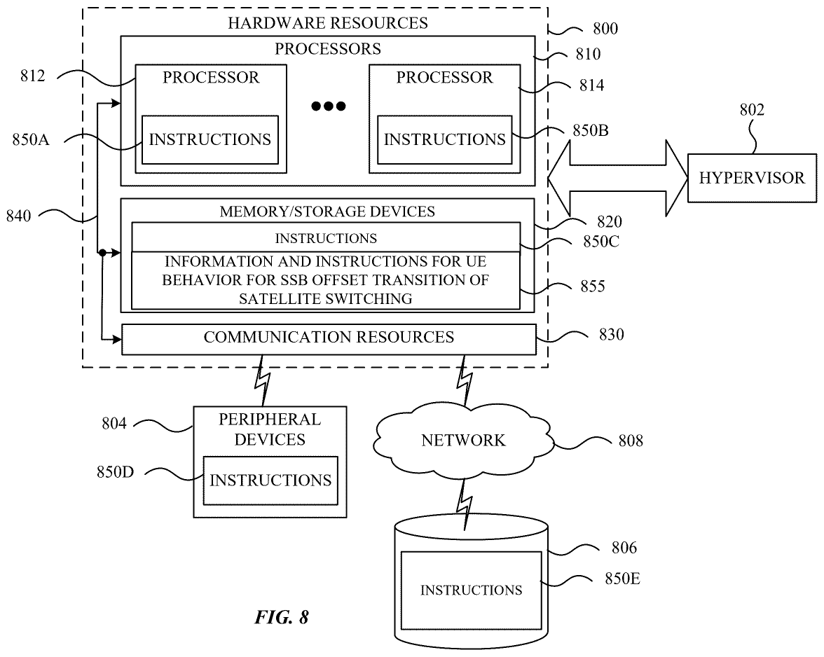

FIG. 8 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 8 shows a diagrammatic representation of hardware resources 800 including one or more processors 810 (or processor cores), one or more memory/storage devices 820, and one or more communication resources 830, each of which can be communicatively coupled via a bus 840. For implementations where node virtualization or network function virtualization is utilized, a hypervisor can be executed to provide an execution environment for one or more network slices/sub-slices to utilize hardware resources 800. Hardware resources 800 can interact with hypervisor 802. For example, hypervisor 802 can schedule or otherwise manage hardware resource 800.

The processors 810 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 812 and a processor 814.

The memory/storage devices 820 can include main memory, disk storage, or any suitable combination thereof. The memory/storage devices 820 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 820 receive and/or store information and instructions 855 for performing satellite switching with SSB offset transition without PCI change. For example, memory 820 can receive, store, and/or provide information and instructions for enabling UE to receive SSBs from satellites, such as a source satellite and a target satellite. In some examples, UE can perform satellite switching from the source satellite to the target satellite, including cell searching and fine time tracking. In some examples, UE can complete cell searching, or cell searching and fine time tracking, prior to the expiration of a coverage overlap period of the target satellite and source satellite. After the coverage overlap period, a time offset can be adjusted. In some examples, UE may not complete cell searching, fine time tracking, or both, prior to the service time. In such examples, synchronization information, such as time offset and search time, can be adjusted. UE can determine the location of the first SSB of the target satellite using timing information and based on whether the SSB was received prior to the service time or after the service time. These and many other features and examples are described herein. These and many other features and examples are discussed herein.

Communication resources 830 can include interconnection or network interface components or other suitable devices to communicate with one or more peripheral devices 804 or one or more databases 806 via a network 808. For example, communication resources 830 can include wired communication components (e.g., for coupling via a universal serial bus), cellular communication components, near field communication components, Bluetooth® components (e.g., Bluetooth® Low Energy), Wi-Fi® components, and other communication components.

Instructions 850A, 850B, 850C, 850D, and/or 850E can comprise software, a program, an application, an applet, an app, or other executable code for causing at least any of processors 810 to perform any one or more of the methodologies discussed herein. Instructions 850 can reside, completely or partially, within at least one of processors 810 (e.g., within a cache memory), memory/storage devices 820, or any suitable combination thereof. Furthermore, any portion of instructions 850A-850E can be transferred to hardware resources 800 from any combination of peripheral devices 804 or databases 806. Accordingly, memory of processors 810, memory/storage devices 820, peripheral devices 804, and databases 806 are examples of computer-readable and machine-readable media.

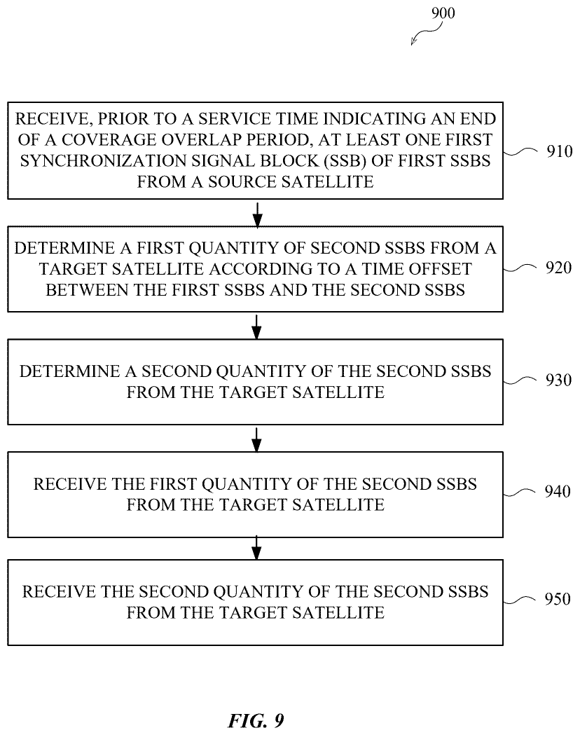

FIG. 9 is a diagram of an example process for SSB offset transition of satellite switching according to one or more implementations described herein. Process 900 can be implemented by UE 210, baseband circuitry, or both. In some examples, FIG. 9 can be an example of a method that can be implemented by UE 210, or another device. In some implementations, some or all of process 900 can be performed by one or more other systems or devices, including one or more of the devices of FIG. 2. Additionally, process 900 can include one or more fewer, additional, differently ordered and/or arranged operations than those shown in FIG. 9. In some implementations, some or all of the operations of process 900 can be performed independently, successively, simultaneously, etc., of one or more of the other operations of process 900. As such, the techniques described herein are not limited to a number, sequence, arrangement, timing, etc., of the operations or processes depicted in FIG. 9.

Process 900 can include receiving, prior to a service time indicating an end of a coverage overlap period, at least one first SSB of first SSBs from a source satellite (block 910). Process 900 can include determining a first quantity of second SSBs from a target satellite according to a time offset between the first SSBs and the second SSBs (block 920). Process 900 can include determining a second quantity of the second SSBs from the target satellite (block 930). Process 900 can include receiving the first quantity of the second SSBs from the target satellite (block 940). Process 900 can include receiving the second quantity of the second SSBs from the target satellite (block 950).

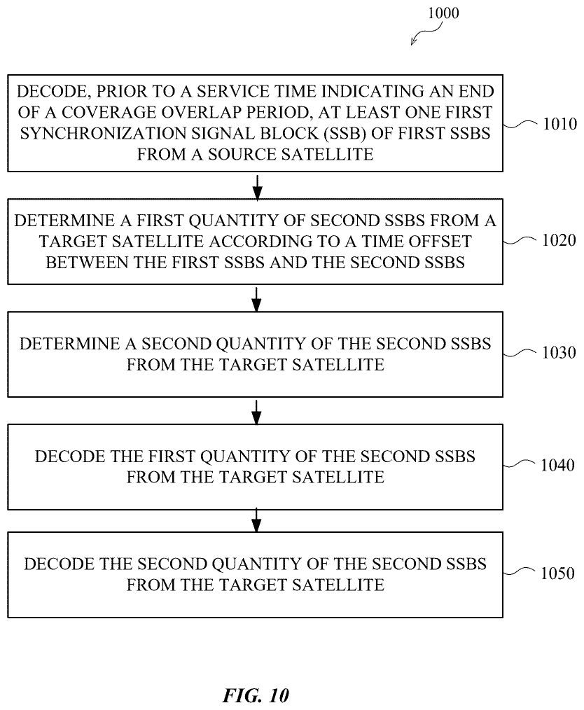

FIG. 10 is a diagram of an example process for SSB offset transition of satellite switching according to one or more implementations described herein. Process 1000 can be implemented by baseband circuitry, such as baseband circuitry of UE 210. In some implementations, some or all of process 1000 can be performed by one or more other systems or devices, including one or more of the devices of FIG. 2. Additionally, process 1000 can include one or more fewer, additional, differently ordered and/or arranged operations than those shown in FIG. 10. In some implementations, some or all of the operations of process 1000 can be performed independently, successively, simultaneously, etc., of one or more of the other operations of process 1000. As such, the techniques described herein are not limited to a number, sequence, arrangement, timing, etc., of the operations or processes depicted in FIG. 10.

Process 1000 can include decoding at least one first SSB of first SSBs from a source satellite (block 1010). Process 1000 can include determining a first quantity of second SSBs from a target satellite according to a time offset between the first SSBs and the second SSBs (block 1020). Process 1000 can include determining a second quantity of the second SSBs from the target satellite (block 1030). Process 1000 can include decoding the first quantity of the second SSBs from the target satellite (block 1040). Process 1000 can include decoding the second quantity of the second SSBs from the target satellite from the target satellite (block 1050).

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a UE (e.g., UE 210) can comprise: a memory; and one or more processors configured to, when executing instructions stored in the memory, cause UE 210 to: receive, prior to a service time indicating an end of a coverage overlap period, at least one first synchronization signal block (SSB) of first SSBs from a source satellite; determine a first quantity of second SSBs from a target satellite according to a time offset between the first SSBs and the second SSBs; determine a second quantity of the second SSBs from the target satellite; receive the first quantity of the second SSBs from the target satellite; and receive the second quantity of the second SSBs from the target satellite.

In example 2, which can also include one or more of the examples described herein, wherein, to receive the first quantity of the second SSBs, the one or more processors are further configured to cause UE 210 to: receive the first quantity of the second SSBs prior to the service time and according to the time offset, wherein the first quantity corresponds to cell searching.

In example 3, which can also include one or more of the examples described herein, wherein, to receive the first quantity of the second SSBs, the one or more processors are further configured to cause UE 210 to: receive a first portion of the first quantity of the second SSBs prior to the service time, wherein the first quantity corresponds to cell searching; receive a second portion of the first quantity of the second SSBs after the service time; and determine a location of a first SSB of the first portion based on a periodicity, a location of the at least one first SSB of the source satellite, the time offset, a difference between a propagation delay of the source satellite and the target satellite counted from a reference point, or a combination thereof.

In example 4, which can also include one or more of the examples described herein, wherein, to receive the first quantity of the second SSBs, the one or more processors are further configured to cause UE 210 to: receive the first quantity of the second SSBs after the service time, wherein the first quantity corresponds to cell searching.

In example 5, which can also include one or more of the examples described herein, the one or more processors are further configured to cause UE 210 to: adjust the time offset to a new time offset; and receive the first quantity of the second SSBs after the service time according to the new time offset.

In example 6, which can also include one or more of the examples described herein, the one or more processors are further configured to cause UE 210 to: adjust the time offset to a new time offset; and determine a location of a first SSB of the first quantity of the second SSBs based on a periodicity, a location of the at least one first SSB of the source satellite, the new time offset, a difference between a propagation delay of the source satellite and the target satellite counted from a reference point, or a combination thereof.

In example 7, which can also include one or more of the examples described herein, wherein, to the one or more processors are further configured to cause UE 210 to: determine a location of a first SSB of the first quantity of the second SSBs based on a periodicity and a location of the at least one first SSB of the source satellite in an SSB-based measurement timing configuration window of the source satellite.

In example 8, which can also include one or more of the examples described herein, the one or more processors are further configured to cause UE 210 to: adjust the time offset to a new time offset for reception of additional second SSBs after the service time; and receive the additional second SSBs according to the new time offset after the service time.

In example 9, which can also include one or more of the examples described herein, the one or more processors are further configured to cause UE 210 to: receive the first quantity of the second SSBs corresponding to cell searching and the second quantity of the second SSBs corresponding to fine time tracking prior to the service time and according to the time offset, wherein the quantity of the second SSBs comprise timing information.

In example 10, which can also include one or more of the examples described herein, wherein, the one or more processors are further configured to cause UE 210 to: receive the second quantity of the second SSBs after the service time, wherein the second quantity corresponds to fine time tracking.

In example 11, which can also include one or more of the examples described herein, wherein, the one or more processors are further configured to cause UE 210 to: adjust the time offset is adjusted to a new time offset; and receive the second quantity of the second SSBs after the service time according to the new time offset.

In example 12, which can also include one or more of the examples described herein, the one or more processors are further configured to cause UE 210 to: adjust the time offset to a new time offset; and determine a location of a first SSB of the second quantity of the second SSBs based on a periodicity, a location of the at least one first SSB of the source satellite, the new time offset, a difference between a propagation delay of the source satellite and the target satellite counted from a reference point, or a combination thereof.

In example 13, which can also include one or more of the examples described herein, the one or more processors are further configured to cause UE 210 to: determine a location of a first SSB of the second quantity of the second SSBs based on a periodicity, a location of the at least one first SSB of the source satellite in an SSB-based measurement timing configuration window of the source satellite.

In example 14, which can also include one or more of the examples described herein, wherein, to receive the first quantity of the second SSBs, the one or more processors are further configured to cause UE 210 to: receive the first quantity of the second SSBs prior to the service time, wherein a time for fine time tracking and acquiring full timing information is a time delay margin for reception of the first quantity of the second SSBs after the service time, or receive the first quantity of the second SSBs after the service time, wherein the time for fine timing and tracking and acquiring the full timing information is the time delay margin for the reception of the first quantity of the second SSBs and the second quantity of the second of SSBs after the service time.

In example 15, which can also include one or more of the examples described herein, wherein the first SSBs and the second SSBs are associated with a frequency and a periodicity.

In example 16, which can also include one or more of the examples described herein, a method at a UE (e.g., UE 210), the method comprising (e.g., the method can comprise): receiving, prior to a service time indicating an end of a coverage overlap period, at least one first synchronization signal block (SSB) of first SSBs from a source satellite; determining a first quantity of second SSBs from a target satellite according to a time offset between the first SSBs and the second SSBs; determining a second quantity of the second SSBs from the target satellite; receiving the first quantity of the second SSBs from the target satellite; and receiving the second quantity of the second SSBs from the target satellite.

In example 17, which can also include one or more of the examples described herein, wherein the method further comprises: receiving the first quantity of the second SSBs prior to the service time and according to the time offset, wherein the first quantity corresponds to cell searching.

In example 18, which can also include one or more of the examples described herein, wherein the method further comprises: receiving a first portion of the first quantity of the second SSBs prior to the service time, wherein the first quantity corresponds to cell searching; receiving a second portion of the first quantity of the second SSBs after the service time; and determining a location of a first SSB of the first portion based on a periodicity, a location of the at least one first SSB of the source satellite, the time offset, a difference between a propagation delay of the source satellite and the target satellite counted from a reference point, or a combination thereof.

In example 19, which can also include one or more of the examples described herein, wherein the method further comprises: receiving the first quantity of the second SSBs after the service time, wherein the first quantity corresponds to cell searching.

In example 20, which can also include one or more of the examples described herein, base baseband circuitry (e.g., baseband circuitry of a UE (e.g., UE 210)) can comprise: a memory; and one or more processors configured to, when executing instructions stored in the memory, cause the baseband circuitry to: decode, prior to a service time indicating an end of a coverage overlap period, at least one first synchronization signal block (SSB) of first SSBs from a source satellite; determine a first quantity of second SSBs from a target satellite according to a time offset between the first SSBs and the second SSBs; determine a second quantity of the second SSBs from the target satellite; decode the first quantity of the second SSBs from the target satellite; and decode the second quantity of the second SSBs from the target satellite.

The examples discussed above also extend to method, computer-readable medium, and means-plus-function claims and implementations, any of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

1. A user equipment (UE), comprising:
a memory; and
one or more processors configured to, when executing instructions stored in the memory, cause the UE to:
receive, prior to an end of a coverage overlap period between a source satellite and a target satellite, a first synchronization signal block (SSB) from a source satellite;
determine that second SSB from the target satellite has not been received by the end of the coverage overlap period;
adjust a time offset between the first SSB and the second SSB based on the second SSB not being received by the end of the coverage overlap period; and
monitor for the second SSB at the adjusted time offset.

2. The UE of claim 1, wherein the one or more processors are further configured to cause the UE to:
receive a third SSB from the target satellite prior to a service time indicating the end of the coverage overlap period and according to the time offset, wherein the third SSB corresponds to cell searching.

3. The UE of claim 1, wherein the one or more processors are further configured to cause the UE to:
receive a third SSB prior to a service time indicating the end of the coverage overlap period, wherein the third SSB corresponds to cell searching;
receive the second SSB after the service time; and
determine a location of the third SSB based on a periodicity, a location of the first SSB of the source satellite, the time offset, a difference between a propagation delay of the source satellite and the target satellite counted from a reference point, or a combination thereof.

4. The UE of claim 1, wherein the second SSB corresponds to cell searching.

5. The UE of claim 4, wherein the one or more processors are further configured to cause the UE to:
receive the second SSB after a service time indicating the end of the coverage overlap period according to the adjusted time offset.

6. The UE of claim 4, wherein the one or more processors are further configured to cause the UE to:
determine a location of the second SSB based on a periodicity, a location of the first SSB of the source satellite, the adjusted time offset, a difference between a propagation delay of the source satellite and the target satellite counted from a reference point, or a combination thereof.

7. The UE of claim 4, wherein the one or more processors are further configured to cause the UE to:
determine a location of the second SSB based on a periodicity and a location of the first SSB of the source satellite in an SSB-based measurement timing configuration window of the source satellite.

8. The UE of claim 1, wherein the one or more processors are further configured to cause the UE to:
receive the second SSB and a third SSB from the target satellite according to the adjusted time offset after the end of the coverage overlap period.

9. The UE of claim 1, wherein the one or more processors are further configured to cause the UE to:
receive a third SSB from the target satellite corresponding to cell searching and a fourth SSB from the target satellite corresponding to fine time tracking prior to the end of the coverage overlap period and according to the time offset, wherein the third SSB and the fourth SSB comprise timing information.

10. The UE of claim 1, wherein, the one or more processors are further configured to cause the UE to:
receive the second SSB after a service time indicating the end of the coverage overlap period, wherein the second SSB corresponds to fine time tracking.

11. The UE of claim 10, wherein the one or more processors are further configured to cause the UE to:
receive the second SSB after the service time according to the adjusted time offset.

12. The UE of claim 10, wherein the one or more processors are further configured to cause the UE to:
determine a location of the second SSB based on a periodicity, a location of the at least one first SSB of the source satellite, the adjusted time offset, a difference between a propagation delay of the source satellite and the target satellite counted from a reference point, or a combination thereof.

13. The UE of claim 10, wherein the one or more processors are further configured to cause the UE to:
determine a location of the second SSB based on a periodicity and a location of the first SSB of the source satellite in an SSB-based measurement timing configuration window of the source satellite.

14. The UE of claim 10, wherein the one or more processors are further configured to cause the UE to:
receive a third SSB from the target satellite prior to a service time indicating the end of the coverage overlap period, wherein a time for fine time tracking and acquiring full timing information is a time delay margin for reception of the second SSB after the service time, or
receive the third SSB after the service time, wherein the time for fine timing and tracking and acquiring the full timing information is the time delay margin for the reception of the third SSB and the second SSB after the service time.

15. The UE of claim 1, wherein the first SSB and the second SSB are associated with a frequency and a periodicity.

16. A method at a user equipment (UE), the method comprising:
receiving, prior to an end of a coverage overlap period between a source satellite and a target satellite, a first synchronization signal block (SSB) from a source satellite;
determining that a second SSB from the target satellite has not been received by the end of the coverage overlap period;
adjusting a time offset between the first SSB and the second SSB based on the second SSB not being received by the end of the coverage overlap period; and
monitoring for the second SSB at the adjusted time offset.

17. The method of claim 16, further comprising:
receiving a third SSB from the target satellite prior to a service time indicating the end of the coverage overlap period and according to the time offset, wherein the third SSB corresponds to cell searching.

18. The method of claim 16, further comprising:
receiving a third SSB prior to a service time indicating the end of the coverage overlap period, wherein the third SSB corresponds to cell searching;
receiving the second SSB after the service time; and
determining a location of the third SSB based on a periodicity, a location of the first SSB of the source satellite, the time offset, a difference between a propagation delay of the source satellite and the target satellite counted from a reference point, or a combination thereof.

19. The method of claim 16,
wherein the second SSB corresponds to cell searching.

20. Baseband circuitry, comprising:
a memory; and
one or more processors configured to, when executing instructions stored in the memory, cause the baseband circuitry to:
decode, prior to an end of a coverage overlap period between a source satellite and a target satellite, a first synchronization signal block (SSB) from a source satellite;
determine that a second SSB from the target satellite has not been received by the end of the coverage overlap period;
adjust a time offset between the first SSB and the second SSB based on the second SSB not being received by the end of the coverage overlap period; and
monitor for the second SSB at the adjusted time offset.
